(19) United States
(12) Patent Application Publication
(10) Pub. No.: US 2010/0245080 A1
(43) Pub. Date: Sep. 30, 2010

(54) Device for food-shelf-life management

(75) Inventor: Chih-Kai Liang, Taipei City (TW)

Correspondence Address: CHARLES E. BAXLEY, ESQUIRE, 90 JOHN STREET, SUITE 309, NEW YORK, NY, 10038, US

(73) Assignee: Kun-Meng LIN

(21) Appl. No.: 12/383,492

(22) Filed: Mar. 25, 2009

(51) Int. Cl. G08B 21/00

(52) U.S. Cl. 340/540

(57) ABSTRACT

A device for food-shelf-life management comprises an electronic recorder that has a display screen and a plurality of operational keys. The operational keys are to be operated for setting a present date, a present time, and expiry dates of shelf life of foods. The display screen serves to present the present date and time, codes, the expiry date, a number of days left before the expiry date, checks and warning symbols.

### BACKGROUND OF THE INVENTION

1. Technical Field

The present invention relates to household appliances and, more particularly, to an electronic device for general users to manage shelf life of food stocks at home.

2. Description of Related Art

With the improvement of life quality, modern people place more importance on food safety and thus pay more attention to food-shelf-life management. However, in practice, food-shelf-life management is not easy because each of the various food stocks in our houses has its own shelf life and has to be watch separately. For example, canned foods usually has relatively long shelf life while fresh fruit can only have its freshness lasting for two or three days.

Therefore, for actively and efficiently protecting people's health, preventing food waste and ensuring various foods, especially those perishables foods, to be consumed in good time, there is a pressing need for a device that facilitates active, effective, and easy management of shelf life of food stocks in our families.

### SUMMARY OF THE INVENTION

In view of the need, one objective of the present invention is to provide a device that helps to easily manage shelf life of food stocks at home. The disclosed device provides functions including, but not limited to, setting calendar date and time, setting expiry dates of food shelf life, giving advanced warning when one or more of the expiry dates become impending, and giving instant warning when the expiry one or more of the expiry dates become due or over due.

According to the present invention, the device for food-shelf-life management comprises an electronic recorder that has a display screen and a plurality of operational keys. The operational keys are to be operated for setting the present date, the present time, and the expiry dates of food shelf life. The display screen serves to present the present date, the present time, codes, expiry dates, numbers of left days before the expiry dates, checks and warning symbols.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of an electronic recorder according to the present invention;

FIG. 2 is an exploded view of the electronic recorder according to the present invention;

FIG. 3 is a schematic drawing depicting a display screen and operational keys of the electronic recorder, wherein display regions in the display screen are shown;

FIG. 4 is a flowchart showing an operational process of the electronic recorder;

FIG. 5 explains steps of time and date calibration for the electronic recorder;

FIG. 6 shows steps to manage food shelf life in a day-left mode in the electronic recorder;

FIG. 7 shows steps to manage food shelf life in a date mode in the electronic recorder;

FIG. 8 shows steps to check days left before the expiry date;

FIG. 9 shows the display screen providing advanced warning when the expiry date becomes impending;

FIG. 10 shows the display screen providing instant warning when the expiry date becomes due;

FIG. 11 shows presentation of the display screen relating to steps of under record clearing; and

FIG. 12 shows presentation of the display screen in low cell status.

### DETAILED DESCRIPTION OF THE PREFERRED EMBODIMENT

While a preferred embodiment is provided hereinafter for illustrating the concept of the present invention as described above, it is to be understood that the components of the embodiment shown in the accompanying drawings are depicted for the sake of easy explanation and need not to be made in scale. Moreover, in the following description, resemble components are indicated by the respectively identical numerals.

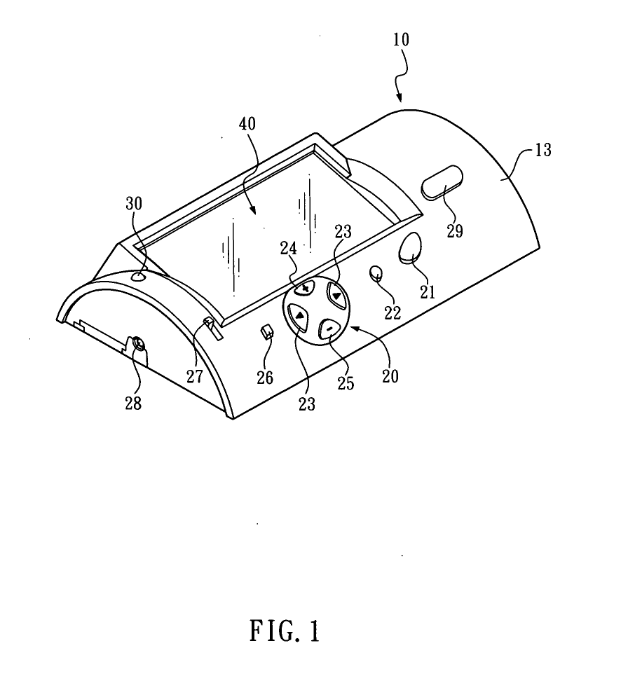

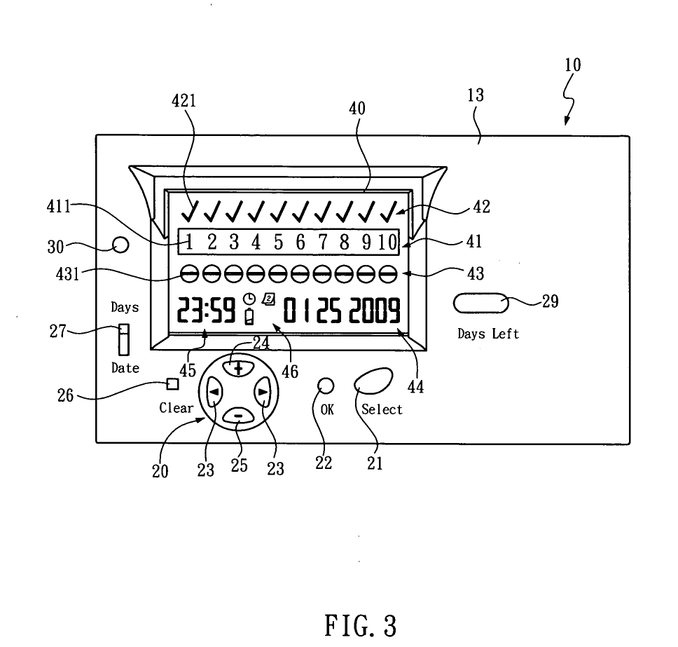

As shown in FIG. 1, a device for food-shelf-life management according to the present invention primarily comprises an electronic recorder 10 and a plurality of tags (not shown) to be attached to packing matters of foods. The electronic recorder 10 uses several codes 411 (shown in FIG. 3) to represent different foods and each said tag carries one said code. Thus, when the tag is attached to the packing matter of the food, the food is associated with the electronic recorder 10 and is recognized by the electronic recorder 10 as an object to be watched. The tag may be attached to the packing matter of the food by means of binding, adhering, magnetic attraction, clamping, sucking, etc. The electronic recorder 10 may be provided with a magnetic element, a sucker, or a high-friction element at a rear side thereof, so that the electronic recorder 10 can be firmly fixed to a physical surface belonging to a food store container. For example, the electronic recorder 10 equipped with a magnetic element can be attached to an outer surface of a refrigerator.

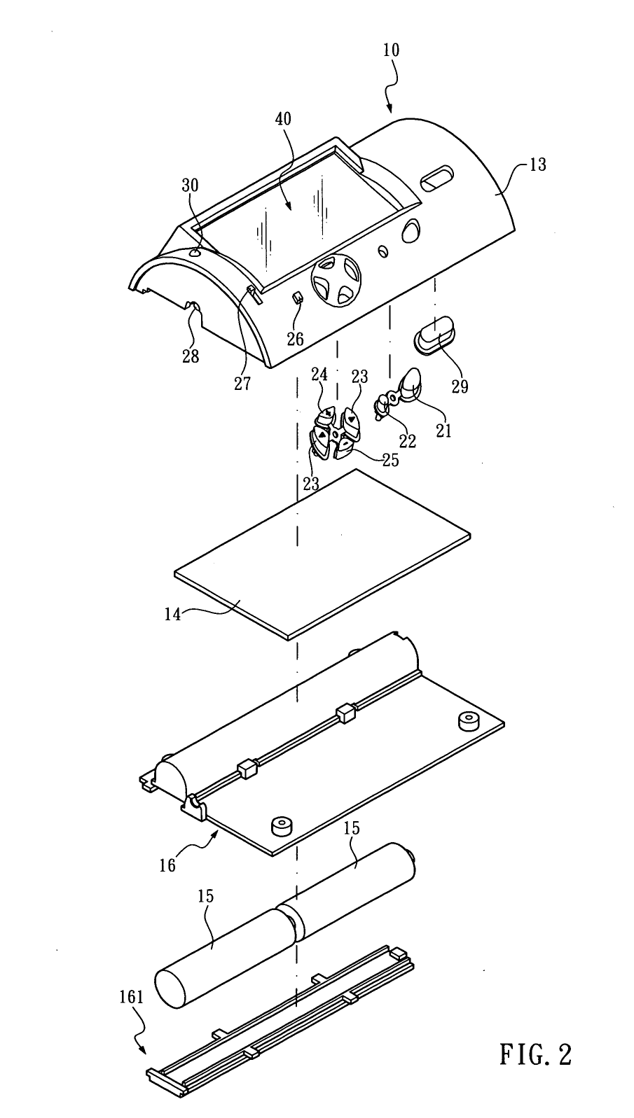

The electronic recorder 10 is hereafter described in detail with reference to FIGS. 1 and 2.

The electronic recorder 10 comprises a housing 13 encloses a PCB 14 and at least one battery 15 connected with the PCB 14. A seal board 16 is assembled to a rear side of the housing 13 and a battery cover 161 is detachably assembled to the seal board 16 so as to shield the battery 15.

A display screen 40, a plurality of operational keys 20 and a warning lamp 30 are assembled to the housing 13 and coupled with the PCB 14.

The plural operational keys 20 include a select key 21, an ok key 22, two shift keys 23, an adding key 24, a reducing key 25, a clear key 26, an expiry-date-setting key 27, a reset key 28, and a day-left key 29.

Referring to FIG. 3, the display screen 40 is divided into several display regions by a program preload in the PCB 14. The display regions include a code region 41, a check region 42, a symbol region 43, a date region 44, a time region 45 and an icon region 46.

The code region 41 is for displaying the plural codes 411 aligned as a line. As mentioned above, each of the codes 411 represents a food to be watched. The codes 411 may be numerals, characters, English letters, or symbols. In the present embodiment, the codes 411 include a sequence of integers, from 1 to 10.

The check region 42 is for displaying the plural checks 421. Each of the checks 421 corresponds to a respective said code 411. The check 421 only appears when the code 411 it corresponds to is used for watching a food. In other words, the codes 411 without being accompanied by checks 421 are those not selected for representing foods to be watched. The checks 421 may appear in a blinking style or a still style.

The date region 44 is for optionally displaying the present date, a said expiry date of food shelf life or a number of days left before the expiry date.

The time region 45 is for displaying the present time.

The warning symbol region 43 is for displaying a plurality of warning symbols 431 that are adjacent and corresponding to the codes 411. When there is only two or three days lefts before the set expiry date of the food represented by the code 411, the warning symbol 431 corresponding to the code 411 appears. The warning symbols 431 may appear in a blinking style or a still style.

The icon region 46 is for displaying functional icons, such as a battery icon showing battery life, a calendar icon indicating that the date is shown, and a clock icon indicating that the time is shown.

By operating the select key 21, a said check 421 in the check region 42 corresponding to an originally unselected said code 411 can be presented, meaning the code 411 now selected.

By operating the shift keys 23, adding key 24, reducing key 25, and the ok key 22, the present date and time can be set and presented in the date region 44 and the time region 45.

By operating the select key 21, expiry-date-setting key 27, adding key 24, reducing key 25, shift keys 23, and the ok key 22, one of the codes 411 can be selected and the expiry date of the food represented by the selected code 411 can be set and presented in the date region 44.

By operating the select key 21, shift keys 23, and the day-left key 29, one of the codes 411 can be selected and the number of days left before the expiry date of the food represented by the selected code 411 can be presented. The number of days left before the expiry date is a result produced by the program preloaded in the PCB 14 through determining a difference between the expiry date and the present date. The number of days left before the expiry date appears at the date region 44 for only several seconds while the present date disappears from the date region 44.

By operating the select key 21, shift keys 23, clear key 26 and the ok key 22, one of the codes 411 can be selected and the check 421, warning symbol 431, and expiry date corresponding to the selected code 411 can be cleared.

By operating the reset key 28, all contents except the codes 411 can be reset.

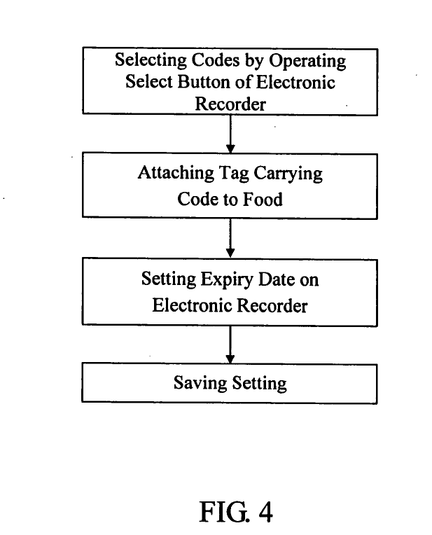

FIG. 4 is a flowchart showing an operational process of the electronic recorder. The process comprising the following steps:

selecting one of the codes by operating the select key of the electronic recorder;

attaching a tag carrying the selected code to a packing matter of a food;

setting an expiry date of shelf life of the food by operating the select key, the adding key, the reducing key, and the shift keys of the electronic recorder; and

saving setting information related to the expiry date by operating the ok key.

The setting method of the electronic recorder will be explained in detailed with reference to the accompanying drawing.

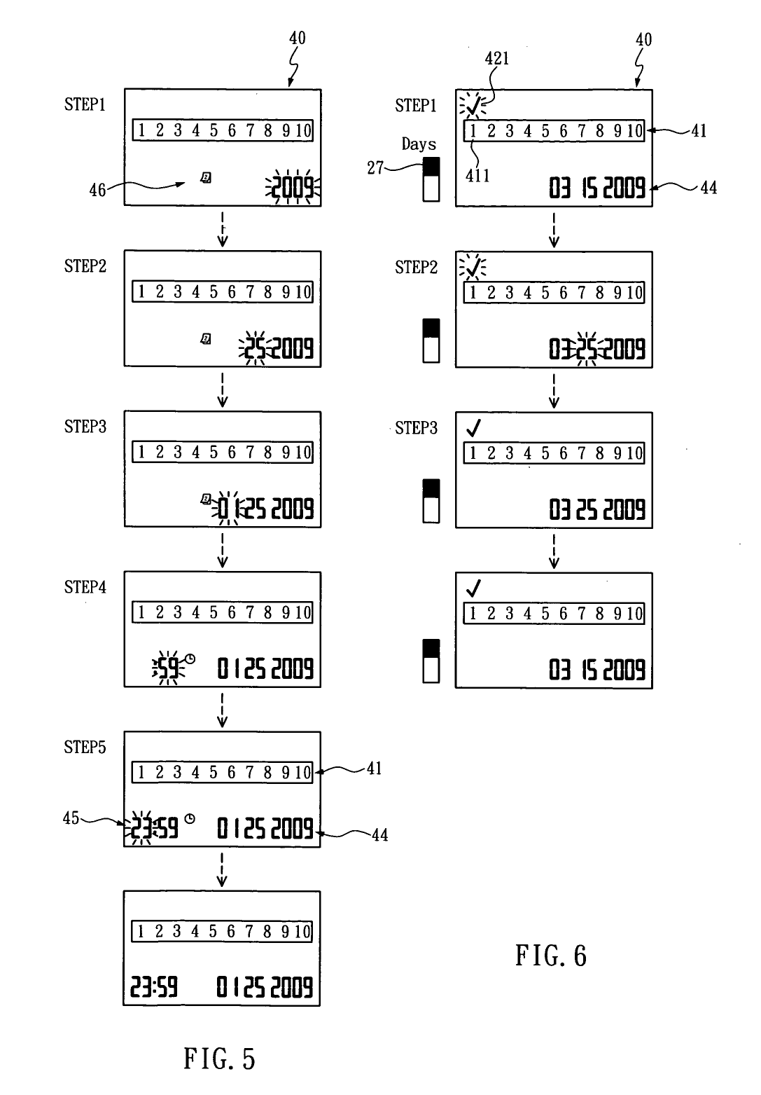

FIG. 5 explains steps of time and date calibration for the electronic recorder. When detecting a new battery installed, the electronic recorder 10 starts and enters a time and date calibration mode automatically. Therefore, numerals and formats for expressing the present date appear at the date region 44 while numerals and formats for expressing the present time appear at the time region 45. At the outset, the numeral representing the current “year” is blinking and the numerals can be altered at this time by operating the adding key 24 and the reducing key 25 (STEP 1). Afterward, by pressing the left shift key 23, the numerals representing the current “day”, “month”, “hour”, and “minute” can be selected and then altered similarly (STEPS 2 to 5). At last, by pressing the ok key 22, the numerals are saved, and the present date and time appear in a still style.

FIG. 6 shows steps to manage food shelf life in a day-left mode in the electronic recorder. As indicated by STEP 1, by operating the select key 21, a said check 421 in the check region 42 corresponding to an originally unselected code 411 can be presented in a blinking style, meaning the code 411 now selected. The expiry-date-setting key 27 is switched to “DAYS”. As indicated by STEP 2, the expiry date can be set by operating the adding key 24 and the reducing key 25 according to a best-before period indicated on the packing material of the food. In STEP 3, setting is finished by pressing the ok key 22. At this time, the check 421 and the expiry date appear in a still style.

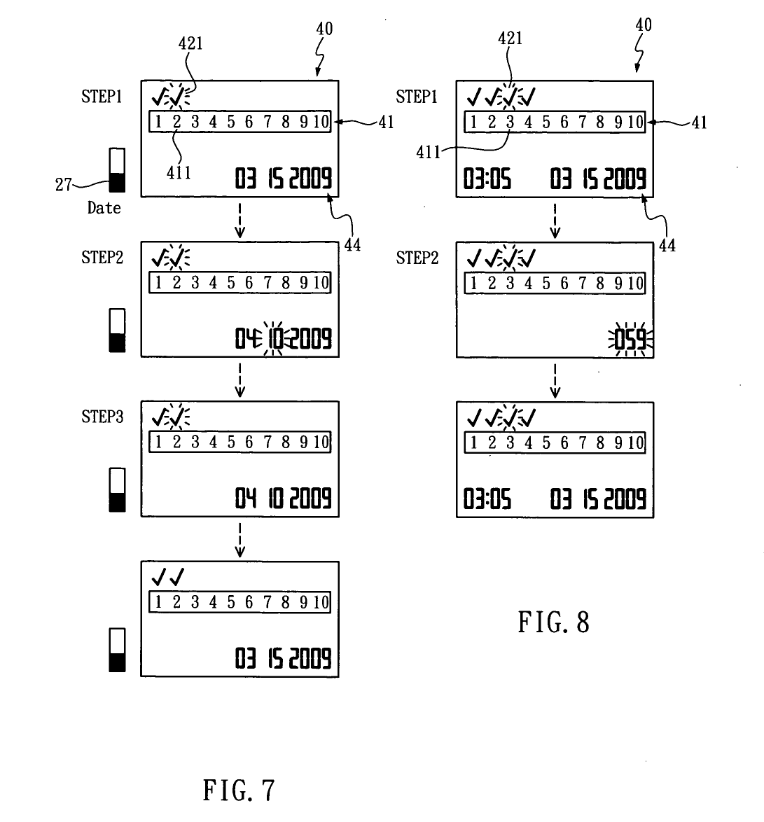

FIG. 7 shows steps to manage food shelf life in a date mode in the electronic recorder. As indicated by STEP 1, by operating the select key 21, a said check 421 in the check region 42 corresponding to an originally unselected code 411 can be presented in a blinking style, meaning the code 411 now selected. The expiry-date-setting key 27 is switched to “DATE”. As indicated by STEP 2, the expiry date can be set by operating the adding key 24 and the reducing key 25 according to an expiry date (year, month, day) indicated on the packing material of the food. In STEP 3, the setting is finished by pressing the ok key 22. At this time, the check and the expiry date appear in a still style.

FIG. 8 shows steps to check days left before the expiry date. As indicated by STEP 1, by operating the select key 21 and the shift keys 23, a said check 421 in the check region 42 corresponding to a said code 411 to be selected can be presented in a blinking style; meaning the code 411 now selected. As indicated by STEP 2, by pressing the day-left key 29, the date region 44 and the time region 45 turn to present the expiry date for several seconds in a blinking style. Afterward, the electronic recorder returns to present the current date and time.

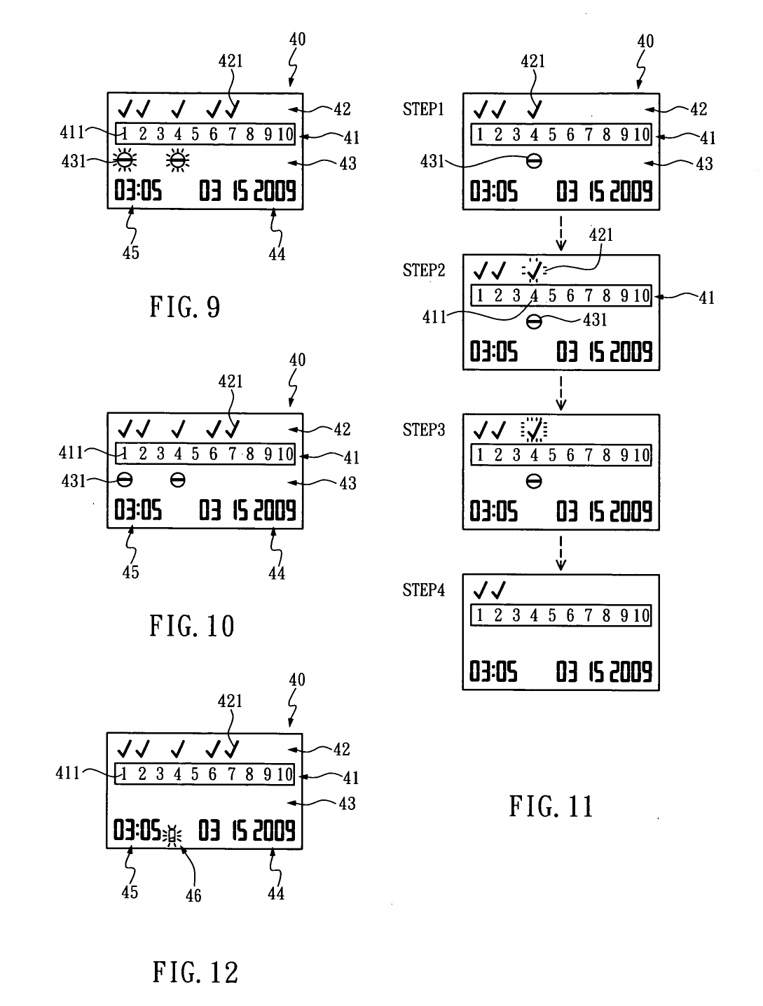

Referring to FIG. 9, when there is only two or three days lefts before the set expiry date of any of the code 411 accompanying the check 421, the warning symbol 431 corresponding to the code 411 appears in a blinking style, thus providing advanced warning. Referring to FIG. 10, when it is the set expiry date of any of the code 411 accompanying the check 421, the warning symbol 431 corresponding to the code 411 appears in a still style and the warning lamp 30 flickers, thus providing instant warning. The appearance of the warning symbol 431 or the warning lamp 30 means the food having the tag carrying the corresponding code 411 shall be consumed or disposed as soon as possible.

Referring to FIG. 11, the checks 421 whose warning messages have been given can be cleared. As shown in STEP 2, by operating the select key 21 and the shift keys 23, a said code 411 whose warning message has been given can be selected and the corresponding check 421 is turned into blinking. By pressing the clear key 26, the blinking check 421 blinks even faster (as shown in STEP 3). At this time, by pressing the ok key 22, the check 421 and the corresponding warning symbol 431 can be cleared (as shown in STEP 4), the warning lamp 30 also going out.

Referring to FIG. 12, when the electronic recorder is in a low battery status, the battery icon in the icon region 46 appears in a blinking style.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A device for food-shelf-life management, the device including an electronic recorder that comprises:
a housing, enclosing a PCB and at least one battery connected with the PCB;
a display screen assembled to the housing and coupled with the PCB, the display screen having a plurality of display regions, the display regions include a code region, a check region, a warning symbol region, a date region, and a time region, the code region displaying plural codes aligned as a line, wherein each of the codes represents a food to be watched, the check region displaying plural checks, each check corresponding to a respective said code, the date region displaying a present date, an expiry date of food shelf life and a number of days left before the expiry date, the time region displaying a present time, and the symbol region displaying plural warning symbols each being adjacent and corresponding to a respective said code; and
a plurality of operational keys assembled to the housing and coupled with the PCB, the plural operational keys including a select key, an ok key, two shift keys, an adding key, a reducing key, a clear key, an expiry-date-setting key, a reset key, and a day-left key.

2. The device as claimed in claim 1, further comprising a warning lamp assembled to the housing and coupled with the PCB.

3. The device as claimed in claim 1, wherein the code includes numerals, characters, English letters, or symbols.

4. The device as claimed in claim 2, wherein the code includes a sequence of integers, from 1 to 10.

5. The device as claimed in claim 1, wherein the display regions of the display screen include an icon region for displaying functional icons.

6. The device as claimed in claim 1, wherein the select key is such operated that a said check in the check region corresponding to an originally unselected said code is presented, meaning the code now selected.

7. The device as claimed in claim 1, wherein the shift keys, the adding key, the reducing key, and the ok key are such operated that the present date and the present time are set and presented in the date region and the time region.

8. The device as claimed in claim 7, wherein the select key, the expiry-date-setting key, the adding key, the reducing key, the shift keys, and the ok key are such operated that one of the codes is selected and an expiry date of a food represented by the selected code is set and presented in the date region.

9. The device as claimed in claim 8, wherein the select key, the shift keys, and the day-left key are such operated that one of the codes is selected and a number of days left before the expiry date of the food represented by the selected code is presented.

10. The device as claimed in claim 9, wherein the number of days left before the expiry date is a result produced by a program preloaded in the PCB through determining a difference between the expiry date and the present date.

11. The device as claimed in claim 10, wherein the number of days left before the expiry date appears at the date region for several seconds.

12. The device as claimed in claim 9, wherein the select key, the shift keys, the clear key and the ok key are such operated that one of the codes is selected and the check, the warning symbol, and the expiry date corresponding to the selected code are cleared.

13. The device as claimed in claim 1, wherein the reset key is such operated that the present date, the present time, all the checks, all the expiry dates, all the warning symbols currently on the electronic recorder are cleared.
